(19) United States
(12) Patent Application Publication
(10) Pub. No.: US 2008/0030352 A1
(43) Pub. Date: Feb. 7, 2008

(54) Methods and systems for gas detection

(75) Inventor: John Edward Andrew Shaw, Middlesex (GB)

Correspondence Address: Gerald Bluhm;Tyco Fire and Security, 50 Technology Drive, Westminster, MA, 01441, US

(73) Assignee: THORN SECURITY LIMITED

(21) Appl. No.: 11/708,172

(22) Filed: Feb. 20, 2007

Related U.S. Application Data
(60) Provisional application No. 60/777,161, filed on Feb. 27, 2006.

(51) Int. Cl. G08B 17/12

(52) U.S. Cl. 340/579

(57) ABSTRACT

Methods and systems for detecting potential fire related conditions are provided. The system includes a sensor that includes a carbon-based nano-structure, the sensor exhibiting an electronic property that varies in response to a presence of a predetermined gas indicative of a potential fire related condition and an evaluation unit, communicating with the sensor, for analyzing the electronic property to determine whether the potential fire related condition exists.

### BACKGROUND OF THE INVENTION

This invention relates generally to gas detection systems and, more particularly, to fire detection systems that employ sensors incorporating carbon-based nano-structures. Carbon-based nano-structures include carbon based particles having at least one dimension of less than 100 nanometers and include especially carbon nanotubes but may encompass as well carbon nanotubes, fullerenes, carbon nanocones, carbon nano-onions, graphene sheet, and nanosized carbon particles of graphitic or amorphous type, and combinations or assemblies based on such particles including aggregates, nets and arrays.

Combustion of fuel in a fire generates heat, and material products of combustion and pyrolysis. Fire detection generally involves sensing of temperature, radiation, or material transferring from the seat of the fire. The combustion and pyrolysis product materials transferred include soot as particulates and solid and liquid aerosols and gases and vapors. Soot particulates or aerosols may form from gases or vapors, for example by condensation processes, and gases and vapors may absorb or desorb from particulate and aerosol materials. Convective, advective, and diffusive processes may be involved in transfer and dispersion of fire products in the surrounding air and carry those products to detector devices.

Gases formed during the burning of the combustible material are generally designated as combustion gases. Most generally the fuels are organic materials resulting in CO, CO₂, and H₂O as the predominantly formed oxides. The starting phase of fires often yield CO, saturated and unsaturated hydrocarbons, alcohols, and acids due to incomplete combustion though these may continue through to well developed fires, especially if oxygen supply is limited. Other products depend on the composition of fuel and other materials, including suppressants, at or adjacent to the fire and on the oxygen supply. Chlorinated polymers such as PVC can give rise to HCl or Cl₂ fumes. Sulfur containing materials can give rise to oxides of sulfur (SO_{X}) including SO₂ and/or SO₃ and under poorly oxygenated conditions to H₂S. Depending on oxygen supply at the fire seat, nitrogen containing fuels such as polyurethanes can produce oxides of nitrogen (NO_{X}) and hydrogen cyanide (HCN) while nitrogen oxides can arise by combination of oxygen and nitrogen in the air at temperatures above 200 degree C. In the presence of water, including water vapor or droplets, acid fumes may be generated including sulfuric acid (H₂SO₄) and nitric acid (HNO₃).

Detection targets produced by fires which may provide useful indication include O₂ depletion, and a rise in levels of H₂O, CO₂, CO, oxides of nitrogen (NO_{X}), and oxides of sulfur (SO_{X}), HCl and a range of gaseous and volatile organic molecules including hydrocarbons, including acetylene, ethylene, ethane, and benzene, and organic molecules incorporating oxygen including products with alcohol and carbonyl groups including for example methanol, formaldehyde, formic acid, acetaldehyde, acetic acid, and acrolein. Changes in concentrations of fire product gases for relatively early stage fires may be of the order of 100 ppm up to a few percent for O₂, CO₂, and H₂O, and 10 to 100 ppm or more for CO. Other gas and vapor concentrations will generally rise to only a few ppm during the early stages of a fire. Variation due to non fire causes and relatively high background levels has mitigated against widespread use of O₂, H₂O, and CO₂ sensing as nuisance fire indicators although their variation in concert with other indicators such as heat, and smoke may provide useful confirmatory indications.

False alarms in fire detection systems can arise by a variety of routes and in some cases sensing levels of gaseous products may improve discrimination between real nuisance fires and false alarm stimuli. The pattern of absence or presence of particular gaseous products with or without detection of aerosols activating smoke detectors, ion, or optical scatter types can be indicative of whether the stimuli arise from fire or non fire sources. For example, a response from a gas sensor sensitive to a simple hydrocarbon known to be used as aerosol propellant or as a fuel (e.g. butane) without response from another sensitive to more oxygenated products such as CO, methanol, formaldehyde may indicate simple vapor emissions rather than a nuisance fire scenario.

Response by a smoke detector coupled with detection of hydrocarbons but not CO may indicate that the signals arise from propellant and aerosols produced by spraying cleaning products, insecticide, air fresheners, or hair spray rather than from fire. An absence of a rise in gases other than H₂O vapor may indicate that the aerosol is condensed water droplets associated with bathroom showers, washing equipment, or cooking rather than fire.

Providing sensors that yield a recognizable gaseous output signature of other known false alarm initiating events such as smoking and cooking, including by use of suitable combinations of signal or algorithms for processing output signals, may be used to enhance discrimination between fire and false alarm events.

At least some known gas sensor systems require catalyst or conductive structures which need to be operated at elevated temperatures to provide adequate response and response times. While such devices provide a range of sensitivities useful for fire gas detection, power requirements have limited the use of such devices to niche applications. Some other gas sensors based on conduction or optical changes in polymeric materials at ambient temperatures have generally shown inadequate response or selectivity to species of interest and in some cases excessive recovery times.

### BRIEF DESCRIPTION OF THE INVENTION

In one embodiment, a system for detecting potential fire related conditions includes a sensor that includes a carbon-based nano-structure, the sensor exhibiting an electronic property that varies in response to a presence of one or more gases from a predetermined group or class of gases indicative of a potential fire related condition and an evaluation unit, communicating with the sensor, for analyzing the electronic property to determine whether the potential fire related condition exists.

In another embodiment, a sensor includes a carbon-based nano-structure configured to respond to the presence of a gas using a chemically responsive electronic property of the carbon nano-structure wherein chemically responsive electronic property includes at least one of current versus applied voltage, resistance, capacitance, impedance, field emission current, diode characteristics, and trans-conductance, and an interface configured to transmit a signal indicative of a change in the electronic property in response to a presence of one or more gases from a predetermined group or class of gases generated by a potential fire related condition.

In yet another embodiment, a method for detecting potential fire related conditions utilizing a sensor that includes a carbon-based nano-structure includes measuring an electronic property of the carbon-based nano-structure that varies in response to a presence of one or more gases from a predetermined group or class of gases indicative of a potential fire related condition, and analyzing the electronic property to determine whether the potential fire related condition exists.

### BRIEF DESCRIPTION OF THE DRAWINGS

FIG. 1 is a schematic diagram of an exemplary fire detector and signaling system in accordance with an embodiment of the present invention;

FIG. 2 is a schematic diagram of an exemplary carbon nanotube based sensor that may be used with the fire detector and signaling system shown in FIG. 1;

FIG. 3 is a schematic diagram of an exemplary embodiment of a carbon nanotube based sensor that may be used with the fire detector and signaling system shown in FIG. 1;

FIG. 4 is a schematic diagram of another exemplary embodiment of a carbon nanotube based sensor that may be used with the fire detector and signaling system shown in FIG. 1;

FIG. 5 is a schematic diagram of a further exemplary embodiment of a carbon nanotube based sensor that may be used with the fire detector and signaling system shown in FIG. 1;

FIG. 6 is a schematic view of another exemplary embodiment of a carbon nanotube based sensor that may be used with the fire detector and signaling system shown in FIG. 1;

FIG. 7 is a schematic view of still another exemplary embodiment of a carbon nanotube based sensor that may be used with the fire detector and signaling system shown in FIG. 1;

FIG. 8 is a schematic diagram of a further exemplary embodiment of a carbon nanotube based sensor that may be used with the fire detector and signaling system shown in FIG. 1;

FIG. 9 is a schematic diagram of an exemplary carbon nanotube based sensor that may be used with the fire detector and signaling system shown in FIG. 1 using a junction type device with asymmetric contacts to a carbon nanotube structure;

FIG. 10 is a schematic diagram of another exemplary carbon nanotube based sensor that may be used with the fire detector and signaling system shown in FIG. 1 using a junction type device incorporating an asymmetric carbon nanotube structure;

FIG. 11 shows is a schematic diagram of another exemplary carbon nanotube based sensor that may be used with the fire detector and signaling system shown in FIG. 1 using a field emission type carbon nanotube structure;

FIG. 12 is a schematic diagram of another exemplary carbon nanotube based sensor that may be used with the fire detector and signaling system shown in FIG. 1 using a field effect transistor type structure;

FIG. 13 is a schematic diagram of another exemplary carbon nanotube based sensor that may be used with the fire detector and signaling system shown in FIG. 1 using a field effect transistor type structure;

FIG. 14 is a schematic diagram of another exemplary carbon nanotube based sensor that may be used with the fire detector and signaling system shown in FIG. 1 including an electrochemical cell enclosed by a cell wall where an electrode structure including carbon nanotubes is formed adjacent to a gas permeable membrane;

FIG. 15 is a schematic diagram of another exemplary carbon nanotube based sensor that may be used with the fire detector and signaling system shown in FIG. 1 using an optical system including a layer of carbon nanotubes to form a chemically sensitive optical filter;

FIG. 16 is a schematic diagram of another exemplary carbon nanotube based sensor that may be used with the fire detector and signaling system shown in FIG. 1 using a layer of carbon nanotubes to form a chemically sensitive optical filter and dual detectors; and

FIG. 17 is a schematic diagram of still another exemplary carbon nanotube based sensor that may be used with the fire detector and signaling system shown in FIG. 1 using a layer of carbon nanotubes to form an optical system.

### DETAILED DESCRIPTION OF THE INVENTION

Materials for gas sensing applications include nanoparticulate materials where a nanoparticulate material is a material with dimensions in at least one dimension of one hundred nanometers or less. Carbon nano-structure based chemosensors generate a signal related to changes in the electronic properties of nanoparticulate material in the presence of, for example, a gas indicative of a fire-related condition. A gas is a fluid that has neither independent shape nor volume. As used herein a “gas” is a substance not in a liquid or solid state, but includes, but is not limited to, particulates suspended in a gaseous medium which may be air, and where the suspended particulates include and are not limited to vapors, atoms, molecules, smoke, fumes, radon, spores, carbon monoxide, carbon dioxide, HCl, Cl₂, sulfur oxides (SO_{X}) including SO₂ and/or SO₃, H₂S oxides of nitrogen (NO_{X}), hydrogen cyanide (HCN), sulfuric acid (H₂SO₄), nitric acid (HNO₃), and combinations thereof. A fire related condition are these conditions where a fire is occurring or has a high potential for a fire occurring. The fire related condition includes smoldering, pyrolysis, and spills or discharges of predetermined substances and of unknown substances.

Due to the relatively small dimensions of nanoparticulates and especially components of carbon nano-structures, their electronic properties are closely linked to the conditions at the nanoparticulate or nano-structure walls. This allows material interacting with the nanoparticulate or nano-structure walls to have substantial effect on the electronic properties. A nano-structure is or includes a structure of atoms aligned in a geometric shape having at least one dimension of 100 nm or less, which shapes are, for example, but not limited to spherical, cylindrical, polyhedral, and conical. Nano-structures sufficiently small may approximate properties of a one dimensional structure. Carbon nanotubes are examples of carbon nano-structures with single nanotubes having generally cylindrical form with diameters of circular cross sections being approximately fifty nanometers or less. Carbon nano-structures include aggregates, nets, arrays, or assemblies of nano-particulate material including carbon nanotubes where the carbon nano-structure properties may result not only from those of the nanoparticulate components but also from interaction between those components including interparticulate contact. The carbon nano-structure properties may be modified by controlling the degree of aggregation or density of nets or arrays on nano-particulates.

Carbon-based nanostructure based sensor signal transduction involves monitoring changes in electronic properties produced by interaction of the nanostructure with the material to be sensed. The intimate contact between molecules to be sensed and the electronic structure of the carbon-based nanostructures such as carbon nanotubes results in effective signal transduction at normal ambient temperatures. Use of devices without or reduced provision of heating allows operation with low power requirements.

While interactions of molecules with carbon-based nano-structures including carbon nanotubes affect the electronic properties at normal ambient temperatures, processes leading to desorption of molecules or reactions consuming molecules may be slow. This can result in a cumulative or dosimeter type response not well suited to following variations with time of molecular concentrations or allowing rapid recovery following transient exposures. Rates of such desorptive or reaction processes at carbon nanotubes may be enhanced by energy inputs to the sensor structure and in particular by applying heat or illumination to the carbon nanotubes. Chemical reaction and desorption may especially be enhanced by illumination of carbon nanotubes at short optical and ultraviolet wavelengths. However continuous application of heat or illumination to carbon nanotubes can result in excessive diminution of the signal elicited by exposure to a given concentration of the species to be sensed whilst increasing sensor power requirements. Intermittent or pulsed application of heat or illumination to the carbon nanotubes can allow adequate build up of sensor response while promoting sensor recovery from transient exposures while power requirements remain lower than for continuous application of heat or illumination. Variations in system output arising from variation in sensor characteristics resulting from the intermittent application of heat or illumination may be removed by time gating the system output, by using differential output for sensing and reference structures which are both exposed to the applications of heat or illumination, or by combination of such methods.

The application of heat or illumination to enhance rates of such desorptive or reaction processes at carbon-based nano-structures may be varied both in terms of exposure times and levels. This variation may be controlled such that exposure times and levels depend on the sensor output. A feedback arrangement may be employed such that an increase in sensor response to the species to be sensed is followed by variation in application of heat or illumination tending to decrease the sensor response and enhance sensor recovery rates. For sensing structures based on carbon-based nano-structures this feedback arrangement will normally take the form of an increase in application of heat or illumination in response to a rise in the concentration of species to be sensed. For applications like fire detection where such rises in relevant species are relatively rare or abnormal conditions the requirements for increased power are limited so that overall sensor power requirements remain low. Sensor output controlling the variation of application of heat or illumination to structures in a sensor system may be based on the characteristics of sensing structures or on differential response of sensing and reference structures. The control of the variation of application heat or illumination to structures in a sensor system may be applied at some threshold of sensor system response or according to an algorithm which may depend on the level and duration of sensor system response. Fire detection may be based directly on sensor system response. Alternatively fire detection may be based on signals corresponding to the level of, or level and duration of, the application of heat or illumination to the structures in the sensor system, which signals may include measures of the power or energy requirements for such application.

Electronic properties for carbon nano-structures and the sensitivity and selectivity of carbon nano-structure based gas responsive chemosensors are affected by nano-particulate type and composition, aggregation or assembly of nano-particulate components and method of device construction and operation. The density of assemblies of carbon nanotubes as nets or arrays may be modified or selected to control conduction behaviour for the overall assemblies. Synthesis of single wall nanotubes generally produces a mixture of semiconductive and metallic nanotubes, with conduction type ratio generally approximating to 3:1. When the nets of single wall nanotubes are provided in a sufficiently high density, the number of metallic nanotubes is sufficiently to provide a metallic conduction character for the overall nets. When the nets of single wall nanotubes are provided in a low density, the number of metallic nanotubes particles becomes too low to maintain a metallic conduction character for the overall nanotubes structure. Instead, the characteristics of the semi-conductive nanotubes particles begin to influence the conduction character of the overall nanotubes structure, thereby forming a net of single wall nanotubes that exhibits increased semi-conductor characteristics. Gas sensitivity is dependant on conduction type, generally being greater for semiconductor carbon nano-structures. For single walled carbon nanotube nets this is controlled by density of deposition.

The conduction type and gas sensitivity can also be modified by preconditioning of carbon nanotube material, such as through exposure to reagents which selectively react with metallic conducting carbon nanotubes. After such treatment, either before or after assembly of the carbon nanotubes into a carbon based nano-structure the material and resultant nano-structure have increased semiconductor characteristics.

The conduction type and gas sensitivity can also be modified by electrical conditioning of carbon nanotube nets or arrays. Application of high currents or voltages to carbon nanotube nets or arrays can change, significantly impair or entirely remove the conduction characteristics of the carbon nanotube nets or array, especially when applied in air or oxygen. Thus, by treating the carbon nanotube nets or arrays with high currents or voltages in a controlled manner, the carbon nanotube nets or arrays may be provided with increased semiconductor properties and gas sensitivity.

Sensitivity and selectivity for carbon nanotube based gas responsive chemosensors is affected by nanotube type and composition, method of device construction and operation, and combination of nanotubes with additions of other materials that modify response.

An embodiment of the present invention concerns a fire detector or fire detector system incorporating at least one sensor responsive to a gas for which response or signal transduction is based on the electronic properties of carbon-based nano-structures where such structures may include carbon nanotubes. The fire detector or detector system may incorporate a group of sensors which in addition to the at least one sensor based on the electronic properties of carbon-based nano-structures may include one or more fire detection sensors from a group including heat or temperature sensors including thermistors, smoke sensors based on optical obscuration, smoke sensors based on optical scattering, smoke sensors based on mobility changes in ionized air, optical flame detectors responding to radiant emissions from flames, electrochemical carbon monoxide sensors, and other sensors. An embodiment of the present invention includes a fire detection system incorporating a sensor group where at least one sensor within the sensor group is a gas responsive sensor based on the electronic properties of carbon-based nano-structures, and where the fire detection system incorporates a control and evaluation device or system which is connected to the sensor group, set up to evaluate the one or more signals supplied by the sensor group, and if necessary, set up to output at least one control signal. The at least one control signal may be used to activate an alarm or notification process. The at least one control signal may be used to modify the operation or signals of devices within the sensor group.

In various embodiments of the present invention, a carbon-based nano-structure is configured to respond to the presence of a gas using a chemically responsive electronic property of the carbon nano-structure. For example, the electronic property may represent a relation between current output versus an applied voltage. Other examples of measurable electronic properties include resistance, capacitance, or impedance across the nano-structure, a field emission current, a diode characteristic, a trans-conductance and the like. Additionally, a change in the chemically responsive property of a carbon-based nano-structure due to the presence of one or more gases from a predetermined group or class of gases may be measured. The chemically responsive property may be measured to identify the interaction of radiation with the electronic structure of the carbon-based nano-structure. The radiation may include, for example, but not limited to electromagnetic radiation and ionizing radiation. In various embodiments, the carbon-based nano-structure constitutes one or more carbon nanotube structures having carbon atoms linked in one or more cylindrical frameworks. The cylindrical framework of carbon nanotubes is formed predominantly of carbon atoms and at least part of the nano-structure has or approximates to a circular symmetry with diameter of less than about 100 nanometers. The carbon nano-structure may have defects causing deviation from simple cylindrical structure and multiple nanotubes may be linked or associated to form a structure. In an embodiment one or more carbon nanotubes has a diameter of less than about 100 nanometers. Alternatively, the carbon nanotubes may be sized to a diameter of between 0.5 and 100 nanometers. Other embodiments of the cylindrical framework include nano-structures having a diameter of less than about fifty nanometers. Still other embodiments of the cylindrical framework include nano-structures having a diameter of about one nanometer. Various diameters of the cylindrical framework are used to change the electronic properties of the nano-structure and/or the nano-structures response to predetermined gases.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

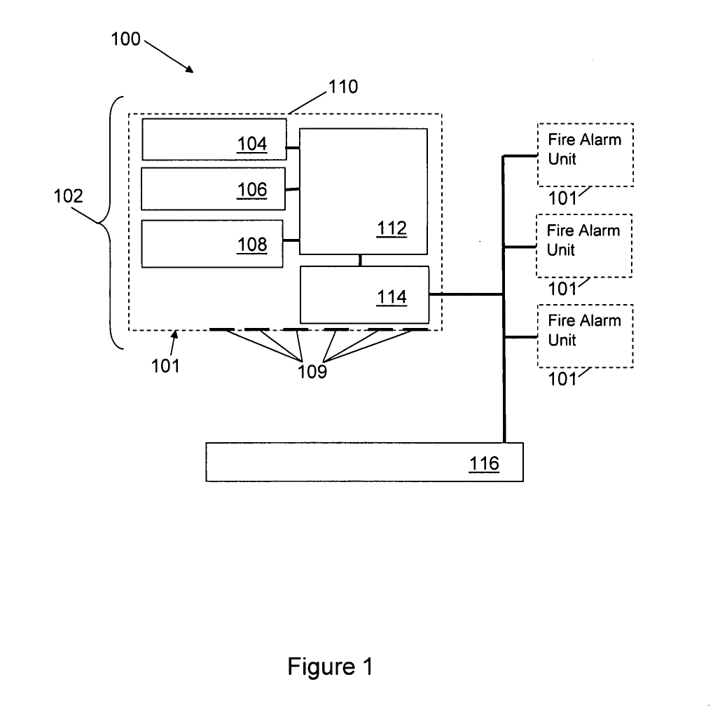

FIG. 1 is a schematic diagram of an exemplary fire detector and signaling system 100 in accordance with an embodiment of the present invention. Fire detector and signaling system 100 includes one or more fire alarm units 101 spaced about an area to be monitored for fire. Each fire alarm unit 101 includes one or more sensor groups 102 with provision for gas transfer between the sensor group 102 and an ambient space external to the fire alarm units 101 that is to be monitored for fire. Sensor groups 102 include for example, but not limited to, one or an array of carbon-based nanostructure based sensors 104, a temperature sensor 106, and a smoke sensor 108. Fire alarm unit 101 includes one or more apertures 109 or other access through an outer cover 110 that provides for gas transfer between the surrounding environment and sensor groups 102. In the exemplary embodiment, protection is provided within one or more of apertures 109 to one or more sensors from the sensor group 102 from ingress by contaminants including particulate materials, which may damage sensor function. Such protection from ingress of contaminants may be provided by gas permeable membranes and/or filters positioned within one or more of apertures 109. In various embodiments, apertures 109 provide selective access to gases in the environment to protect against damaging contaminants and to facilitate improving selectivity of the sensors within sensor group 102. Apertures 109 also provide protection from radiation, for example, optical radiation, which may affect the sensor output or induce degradation of the components of fire alarm unit 101. Outer cover 110 is configured to facilitate reducing excessive air movement impinging on the sensors of sensor group 102, which may induce stresses affecting the sensor output or induce degradation of the sensors of sensor group 102.

At least one of the sensors within one or an array of carbon based nanostructure based sensors 104 is responsive to gases within the ambient space based on the chemically responsive electronic properties of carbon-based nanostructures, which may include carbon nanotube based sensors. The carbon-based nanostructure based sensor incorporates one or more structures formed from one or more carbon-based nanostructures, the electronic properties of which one or more carbon-based nanostructures are or have been rendered chemically sensitive such that the one or more structures respond by a change of electronic properties to the presence of one or more predetermined gases, for example, fire detection indicative gases or vapors. Such gases and vapors include vapors that are generated or consumed by combustion or by fuel pyrolysis, or are associated with false fire alarm conditions. Sensor groups 102 may additionally include one or more other types of fire detection sensors such as temperature sensors, heat sensors including thermistors, ionization type smoke sensors, smoke sensors based on mobility changes in ionized air, smoke sensors based on optical obscuration, smoke sensors based on optical scattering, electrochemical gas sensors including electrochemical carbon monoxide sensors, and flame detectors responding to radiant emissions from flames.

Sensor groups 102 are selected to detect emissions of at least one of the products associated with fire including combustion gas, smoke, flame, and heat. One or an array of carbon-based nanostructure based sensors 104 is selected to provide one or more output signals related to the presence of gases associated with fire using a change in the electronic properties of nano-particulate materials and especially using a change in the electronic properties of carbon-based nano-structures. Signals relative to a concentration and/or presence of the products associated with fire are transmitted to a local signal assessment and control unit 112 that includes a microprocessor and an analog-digital converter for converting the signals supplied by sensor group 102 into corresponding digital signals. The signals received from each of sensor groups 102 may be evaluated and a result of the evaluation transmitted through a communication bus system 114 to a system assessment and control unit 116. Such evaluation may include a combination or integration of the various sensors in such sensor groups with sensor signal conditioning and evaluation systems with output to alarm or notification devices.

In the exemplary embodiment, an overall signal assessment and control function is performed using system assessment and control unit 116 at a single location. In an alternative embodiment, the overall signal assessment and control function is performed using system assessment and control unit 116 and/or one or more local signal assessment and control units 112 communicatively coupled together in a distributed network. In the exemplary embodiment, a plurality of carbon-based nanostructure based sensors are provided with array 104 and configured to respond to two or more gases wherein those gases include gases generated in fires or associated with false alarm stimuli. The gases to which the carbon nanotube based sensors respond are selected based on the materials present in the monitored space and the gases those materials generate when combusting or being subject to pyrolysis. A range of gaseous emissions are associated with various fire types depending on fuel type, ignition conditions, fire progression, and ventilation.

A plurality of sensors provides sufficient information to permit a range of conditions to be recognized to indicate fire or non fire situations. Signals received from sensor group 102 are processed to condition, modify, or combine the signals and the resultant is transmitted to system assessment and control unit 116 and/or one or more alarm, notification, or display units. The sensors of sensor group 102 incorporate a low power requirement to permit operation in battery operated equipment and/or in systems where a plurality of sensors are powered by one electrical circuit.

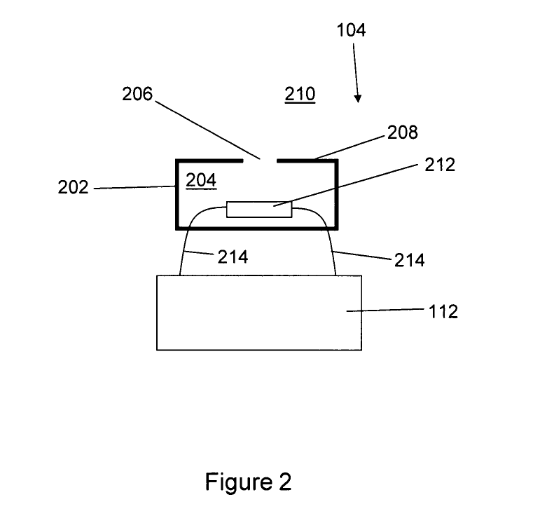

FIG. 2 is a schematic diagram of an exemplary carbon-based nanostructure based sensor 104 that may be used with fire detector and signaling system 100 (shown in FIG. 1). Carbon-based nanostructure based sensor 104 includes a housing 202 enveloping a volume 204. An opening 206 in a sidewall 208 of housing 202 provides access to volume 204 from an ambient space 210 to permit gas or vapor access to a sensing element 212. Signals generated by sensing element 212 are transmitted to local signal assessment and control unit 112 (shown in FIG. 1) through electrical leads 214 routed through sidewall 208. Sensing element 212 is protected from electromagnetic interference (EMI) using shielding and circuit protection.

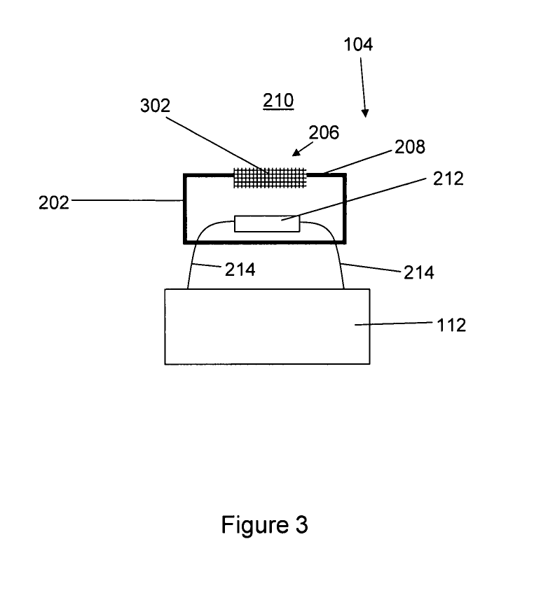

FIG. 3 is a schematic diagram of an exemplary embodiment of carbon-based nanostructure based sensor 104 that may be used with fire detector and signaling system 100 (shown in FIG. 1). Carbon-based nanostructure based sensor 104 includes housing 202 enveloping volume 204. Opening 206 in sidewall 208 of housing 202 provides access to volume 204 from ambient space 210. A gas permeable membrane and/or filter 302 substantially covers opening 206 and restricts access of particulate matter into volume 204 while permitting gas and/or vapor access to sensing element 212. Signals generated by sensing element 212 are transmitted to local signal assessment and control unit 112 (shown in FIG. 1) through electrical leads 214 routed through sidewall 208. In an embodiment of the present invention, gas permeable membrane, and/or filter 302 is electrically conductive to provide electrical contact to sensing element 212.

Gas permeable membrane and/or filter 302 provide protection against contamination by particulate materials and provide a selective response to those gases which may permeate through gas permeable membrane and/or filter 302. In various embodiments, gas permeable membrane and/or filter 302 includes materials having absorbent, reactive, and/or catalytic properties to provide selective gas permeability to gas permeable membrane and/or filter 302. Gas permeable membrane and/or filter 302 also provides selective gas transfer so as to restrict access to the sensor of contaminant gases or vapors, and gases or vapors that may cause false alarm conditions. Gas permeable membrane and/or filter 302 may incorporate absorbent materials including, for example, active carbon materials and/or catalyst materials to facilitate decomposition or oxidation of gases or vapors that may act as contaminants or false alarm stimuli. Gas permeable membrane and/or filter 302 may also include electrically conductive structures or materials, for example, as may be formed by compressive agglomeration of conductive fibers or powders. Gas permeable membrane and/or filter 302 may further provide screening against electromagnetic radiation and electromagnetic radiation effects. Gas permeable membrane and/or filter 302 may also provide one or more conductive links to sensing element 212 and may provide direct electrical contact to carbon nanotube material forming at least a portion of sensing element 212. Gas permeable membrane and/or filter 302 may incorporate conductive materials including a fibrous or particulate form held, compressed, or sintered to form a porous structure.

Gas permeable membrane and/or filter 302 may also incorporate carbon, or metals including various steels, nickel, and bronze individually or as composites of such materials, with or without non-conductive components. Conductive materials may be combined with gas permeable membrane and/or filter 302 to provide desired electronic or chemical contact to sensing element 212. Such contact materials may include noble and catalytic metals including gold, platinum, and palladium where palladium is a preferred contact material for carbon nanotubes where diode effects at contacts are to be reduced or eliminated.

In an embodiment of the present invention, sensing element 212 generates an output using chemically responsive electronic properties of carbon nanotube structures that include a structure of one or more carbon nanotubes provided with two or more electrically conductive contacts disposed in contact with or adjacent to the one or more carbon nanotubes to allow a measurement of electronic response to the presence of a predetermined gas. The measured electronic response may be a change in one or more electrical characteristics of the one or more carbon nanotubes in sensing element 212, for example, but not limited to current versus applied voltage, resistance, impedance of the resistive structure, capacitance, impedance, field emission current, and diode characteristics.

Electrical contact to the carbon nanotubes may be provided by electrically conductive structures formed from metal or other conductive materials including conductive carbon, conductive polymers, and conductive composite compositions incorporating conductive and non conductive materials including polymeric binders. Electrical contacts to the carbon nanotubes may formed by vapor deposition, sputtering, electro-deposition, electroless deposition, printing methods, molding, pressing on preformed contacts or combinations thereof. In various embodiments, the electrical contact layers are positioned under, over or mixed with at least a portion of the carbon nanotubes, carbon nanotube body, or layer and are defined by at least one of physical masking, printing, molding and photolithographic methods, for example, using a lift off processing. In an alternative embodiment, electrical contact is made via pressure contacts using metallic contacts pressed onto, for example, a body or assemblage of carbon nanotubes, or a composite body including carbon nanotubes.

In various embodiments, carbon nanotubes 408 are formed or grown as mats, nets or assembled into bodies or sheets that include nanotubes alone or are composites of nanotubes with other materials. Mats, nets, bodies, or sheets of carbon nanotubes are employed in structures where one or more electrical contacts to the carbon nanotubes is made by vapor deposition, sputtering, electro-deposition, electrolysis deposition, printing methods, molding, pressing on preformed contacts or combinations thereof.

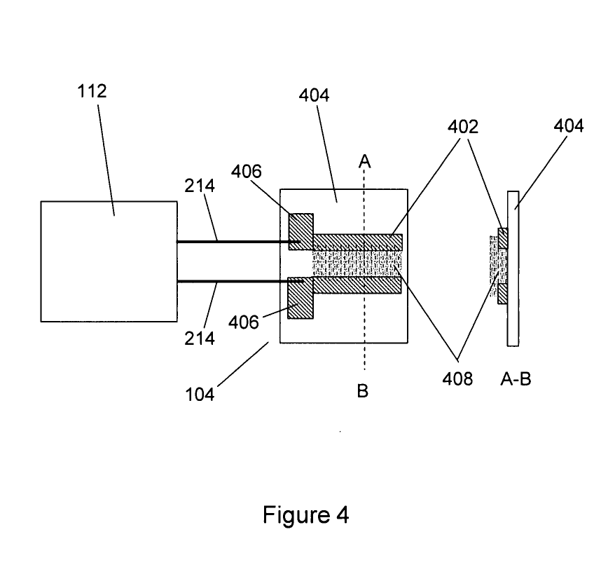

FIG. 4 is a schematic diagram of another exemplary embodiment of carbon nanotube based sensor 104 that may be used with fire detector and signaling system 100 (shown in FIG. 1). In the exemplary embodiment, carbon nanotube based sensor 104 includes contacts 402 disposed on an electrically insulating substrate 404. Contacts 402 include contact pads 406 that provide a relatively larger connection point to contacts 402 for connector wires 214. One or more carbon nanotubes 408 are deposited between and in contact with contacts 402 to form a resistive structure. A cross-sectional view A-B of carbon nanotube based sensor 104 is shown along the line marked A to B. Carbon nanotubes 408 are deposited using for example, but not limited to, growth in situ, deposition of pregrown material, or deposition of components or composite material formed from pregrown material. The electrically insulating substrate 404 may form part of housing partially or fully enclosing the sensor 104. The electrically insulating substrate 404 may be porous or permeable to one or more gases.

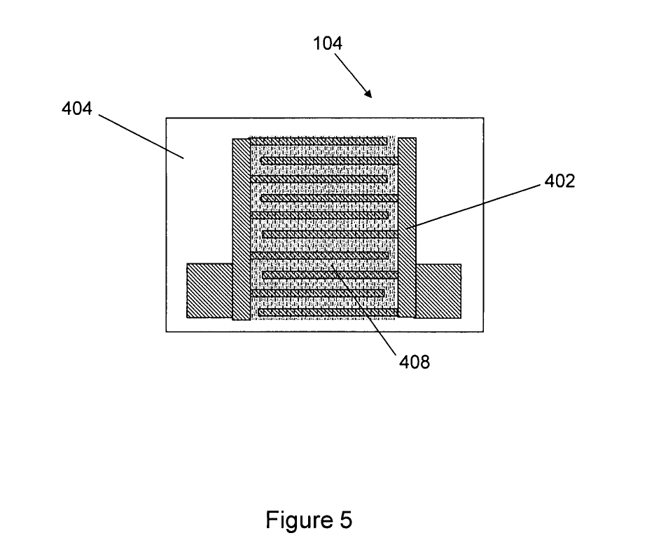

FIG. 5 is a schematic diagram of a further exemplary embodiment of carbon nanotube based sensor 104 that may be used with fire detector and signaling system 100 (shown in FIG. 1). To reduce electrical resistance between contacts 402 and carbon nanotubes 408, the geometry of contacts 402 is modified to increase the contact area between contacts 402 and carbon nanotubes 408. In the exemplary embodiment, carbon nanotube based sensor 104 includes contacts 402 interdigitated with respect to each other. Carbon nanotubes 408 extend between each finger of the interdigitated contacts and/or extend across more than two fingers. Carbon nanotubes 408 may make contact with the fingers from above or below with respect to substrate 404.

Mats, bodies, or sheets of carbon nanotubes are employed in structures where one or more electrical contacts to the carbon nanotubes is made by pressing an electronically conducting material, for example, metals, against the mat, body or sheet to couple the conducting material to the carbon nanotube body.

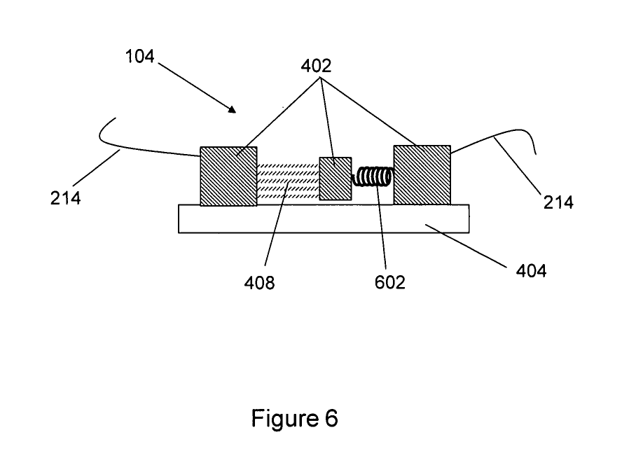

FIG. 6 is a schematic view of another exemplary embodiment of carbon nanotube based sensor 104 that may be used with fire detector and signaling system 100 (shown in FIG. 1). Carbon nanotube based sensor 104 includes contacts 402 coupled to carbon nanotube material 408 under pressure which may be maintained by a bias component 602.

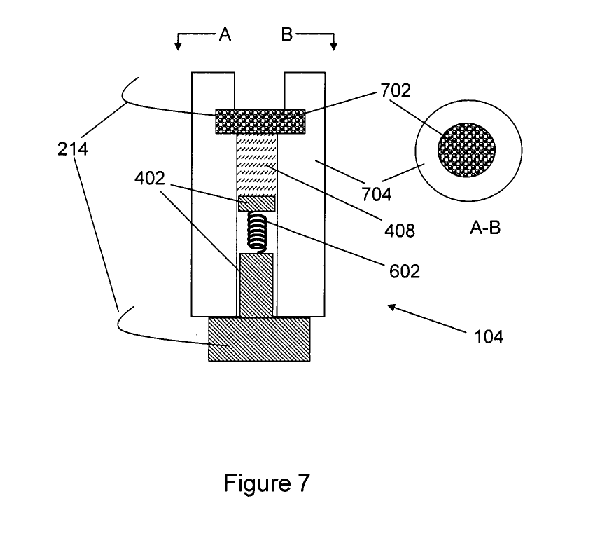

FIG. 7 is a schematic view of still another exemplary embodiment of carbon nanotube based sensor 104 that may be used with fire detector and signaling system 100 (shown in FIG. 1). In the exemplary embodiment, carbon nanotube based sensor 104 includes a gas permeable contact 702 that includes a conductive component structure. carbon nanotube based sensor 104 includes an insulating housing 704 substantially enclosing carbon nanotubes 408 wherein carbon nanotubes 408 are retained between gas permeable contact 702 and contacts 402 under pressure maintained by, for example, bias component 602. A cross-sectional view of carbon nanotube based sensor 104 taken along line A-B is also illustrated in FIG. 7.

Other electrical properties of carbon nanotube structures 408 within carbon nanotube based sensor 104 than simple resistivity may be monitored. For example, structures similar to those illustrated in FIGS. 4 through 7 may include an insulating layer between carbon nanotubes 408 and at least one contact 402 for capacitive measurements. Using alternating current excitation at various frequencies permits impedance measurements resulting in measurements of resistance and capacitance present in carbon nanotube based sensor 104.

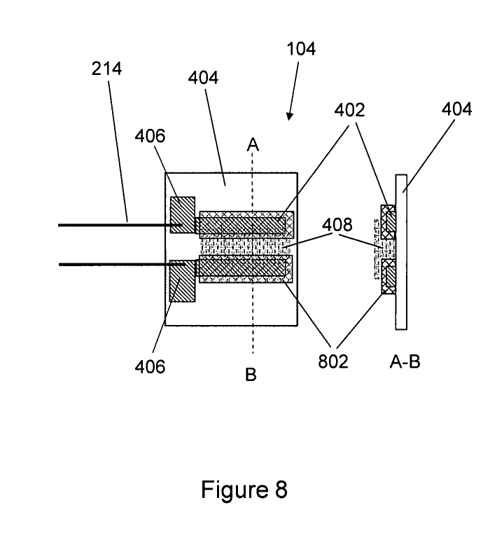

FIG. 8 is a schematic diagram of a further exemplary embodiment of carbon nanotube based sensor 104 that may be used with fire detector and signaling system 100 (shown in FIG. 1). In the exemplary embodiment, carbon nanotube based sensor 104 includes contacts 402 disposed on an electrically insulating substrate 404. Contacts 402 include contact pads 406 that provide a relatively larger connection point to contacts 402 for connector wires 214. One or more carbon nanotubes 408 are deposited between and in contact with contacts 402 to form a resistive structure. A cross-sectional view A-B of carbon nanotube based sensor 104 is shown along the line marked A to B. An insulating layer 802 covers at least a portion of contacts 402 such that insulating layer 802 is positioned between carbon nanotubes 408 and contacts 402 forming a capacitive structure. A cross-sectional view A-B of carbon nanotube based sensor 104 is shown along the line marked A to B. Sensor response to gas or vapor of interest is by a change in the electrical characteristics including capacitance or impedance.

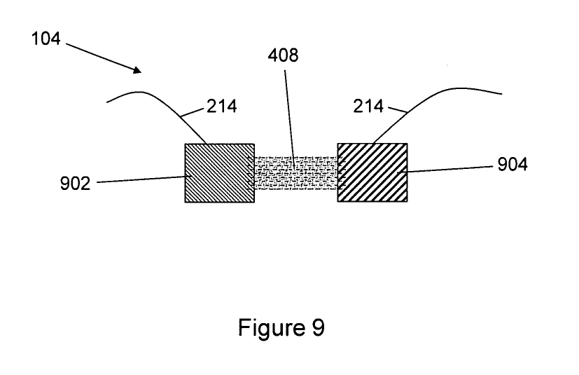

FIG. 9 is a schematic diagram of an exemplary carbon nanotube based sensor 104 that may be used with fire detector and signaling system 100 (shown in FIG. 1) using a junction type device with asymmetric contacts to a carbon nanotube structure. In the exemplary embodiment, carbon nanotubes 408 are electrically coupled between a first contact 902 that is fabricated from a material having a first set of electronic conducting and/or semiconductor properties and a second contact 904 that is fabricated from a material having a second set of electronic conducting and/or semiconductor properties wherein the first and second sets of properties are different. For example, a contact using a Palladium material coupled to carbon nanotubes 408 may be used to facilitate reducing rectifying properties at the contact using Palladium. Sensor response to gas or vapor of interest is by a change in the electrical characteristics including diode characteristics or thermoelectric characteristics including thermoelectric power of the one or more junction structures.

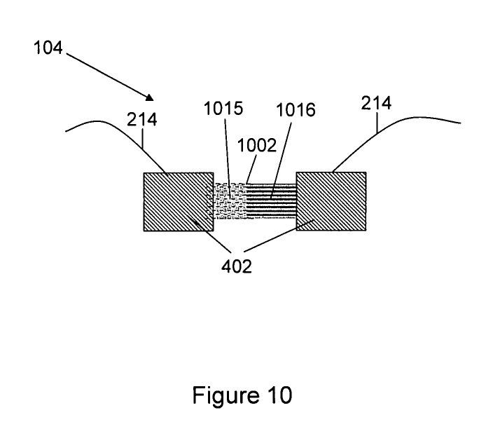

FIG. 10 is a schematic diagram of another exemplary carbon nanotube based sensor 104 that may be used with fire detector and signaling system 100 (shown in FIG. 1) using a junction type device incorporating an asymmetric carbon nanotube structure. In the exemplary embodiment, the carbon nanotubes form a structure with a junction 1002 between two different types of carbon nanotube 1015 and 1016. In the exemplary embodiment, contacts 402 are fabricated substantially identically. In an alternative embodiment, contacts 402 are fabricated from different materials and/or combinations of materials. Sensor response to gas or vapor of interest is by a change in the electrical characteristics including diode characteristics or thermoelectric characteristics including thermoelectric power of the one or more junction structures.

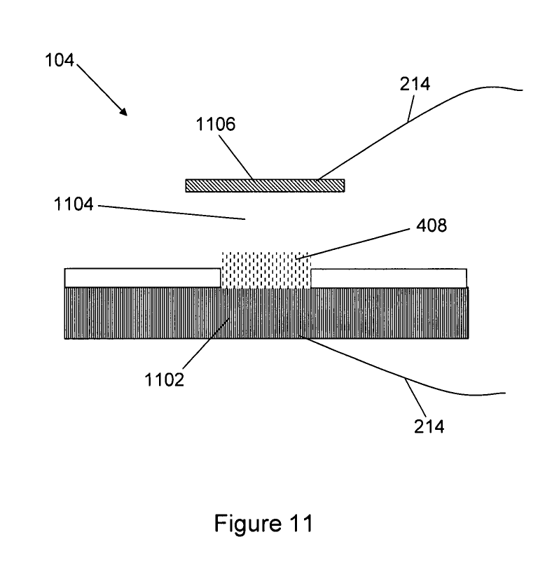

FIG. 11 is a schematic diagram of another exemplary carbon nanotube based sensor 104 that may be used with fire detector and signaling system 100 (shown in FIG. 1) using a field emission type carbon nanotube structure. In the exemplary embodiment, carbon nanotube based sensor 104 includes a conductive substrate 1102. Carbon nanotubes 408 are coupled to conductive substrate 1102 such that field emission points are formed in a gas accessible space 1104 between carbon nanotubes 408 and a counter electrode 1106.

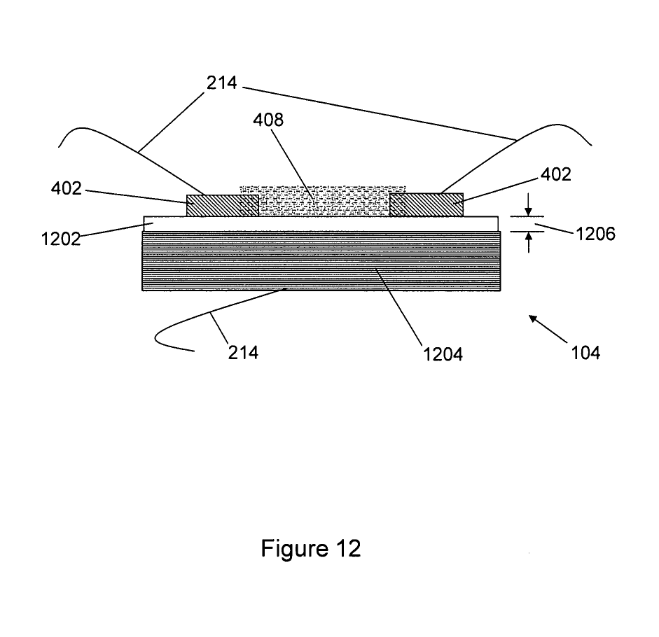

FIG. 12 is a schematic diagram of another exemplary carbon nanotube based sensor 104 that may be used with fire detector and signaling system 100 (shown in FIG. 1) using a field effect transistor type structure. In the exemplary embodiment, carbon nanotubes 408 are coupled between electronically conducting contacts 402. An insulating layer 1202 is positioned between carbon nanotubes 408 and an electrically conducting or semiconductor substrate 1204. In the exemplary embodiment, insulating layer 1202 comprises a silicon oxide on silicon wherein insulating layer 1202 is fabricated to a thickness 1206 of approximately 10 to 500 nanometers. In the exemplary embodiment, carbon nanotube based sensor 104 includes a structure of one or more carbon nanotubes 408 coupled to two or more electrically conductive contacts disposed in contact with or adjacent to the one or more carbon nanotubes 408 and one or more electronically conducting the electrically conducting or semiconductor substrate 1204 wherein an electronic response to the presence of a predetermined gas is measured using the three or more electrical contacts. The measured electronic response may be a change in one or more electrical characteristics including, but not limited to an output current versus applied voltage, resistance, capacitance, impedance, field emission current, diode characteristics, and field effect transistor characteristics which may include a change in trans-conductance or changes in applied potential for devices operated with fixed trans-conductance.

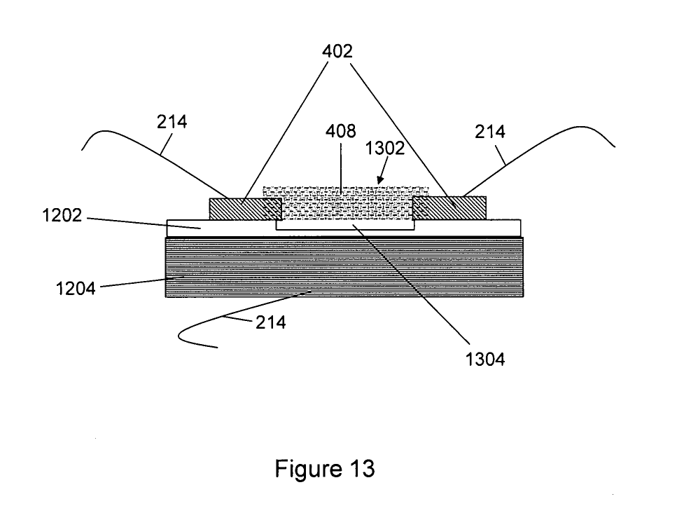

FIG. 13 is a schematic diagram of another exemplary carbon nanotube based sensor 104 that may be used with fire detector and signaling system 100 (shown in FIG. 1) using a field effect transistor type structure. In the exemplary embodiment, carbon nanotubes 408 are coupled between electronically conducting contacts 402 to form a bridge structure 1302 separated from insulating layer 1202 and semiconductor substrate 1204 by a gap 1304. Eliminating contact between insulating layer 1202 and carbon nanotubes 408 facilitates reducing sensitivity to materials absorbed by insulating layer 1202. In an exemplary fabrication method, gap 1304 is formed by etching a portion of insulating layer 1202 after deposition of the layer of carbon nanotubes 408. The measured electronic response of carbon nanotube based sensor 104 may be a change in one or more electrical characteristics including, but not limited to, resistance, capacitance, impedance, and trans-conductance.

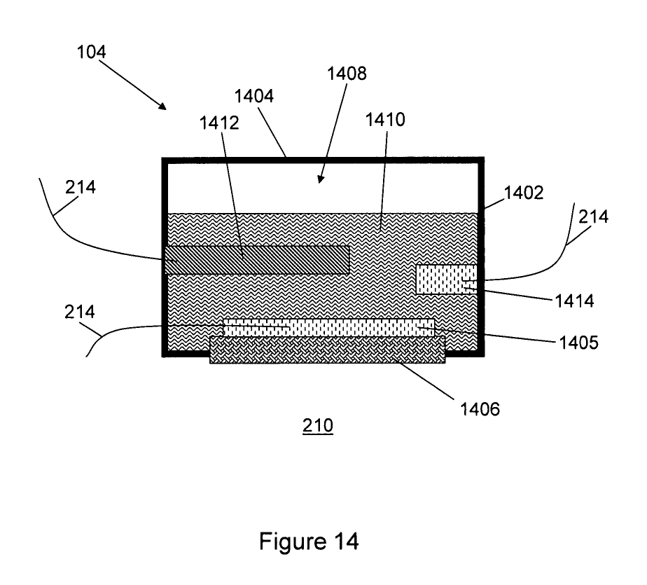

FIG. 14 is a schematic diagram of another exemplary carbon nanotube based sensor 104 that may be used with fire detector and signaling system 100 (shown in FIG. 1) including an electrochemical cell 1402 enclosed by a cell wall 1404 where an electrode structure 1405 including carbon nanotubes 408 is formed adjacent to a gas permeable membrane 1406. Membrane 1406 permits exchange of gases or vapors between ambient space 210 and an interior 1408 of electrochemical cell 1402. Gas permeable membrane 1406 substantially prevents egress of an electrolyte 1410 positioned within interior 1408. In the exemplary embodiment, electrochemical cell 1402 includes one or more counter electrodes 1412 and/or reference electrodes 1414. Counter electrode 1412 permits current flow from electrode structure 1405. Reference electrode 1414 permits control or measurement of a potential of electrode structure 1405. In an embodiment of the invention, carbon nanotube based sensor 104 including electrochemical cell 1402 is configured to operate similarly as known conventional fire detection devices without the expense of using working electrodes comprised predominantly of noble or catalytic metals such as gold or platinum. The measured electronic response of carbon nanotube based sensor 104 may be a change in one or more electrical characteristics including, but not limited to, electrode potential, cell current, or combination of potential and current or cell impedance.

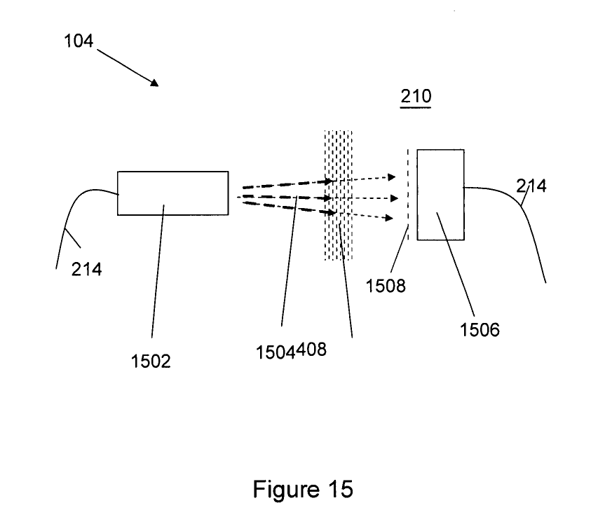

FIG. 15 is a schematic diagram of another exemplary carbon nanotube based sensor 104 that may be used with fire detector and signaling system 100 (shown in FIG. 1) using an optical system including a layer of carbon nanotubes 408 forming a chemically sensitive optical filter. carbon nanotube based sensor 104 includes a radiation source 1502 that emits a beam of radiation 1504 configured to transmit at least partially through the layer of carbon nanotubes 408 and impinge a detector 1506, which may incorporate a wavelength restrictive filter 1508, and which detector 1506 generates an output signal representative of the amount of radiation received. The attenuation radiation beam 1504 is dependant on the interaction of radiation beam 1504 with the electronic properties of carbon nanotubes 408. The structure of carbon nanotubes 408 is configured to respond to a concentration of gases or vapors from the ambient space 210 contacting carbon nanotubes 408 and affecting the electronic properties of the carbon nanotube structures.

Changes in the electronic properties of carbon nanotube structures are monitored by means of interaction between the one or more carbon nanotubes with electromagnetic radiation. Such electromagnetic radiation includes at least a portion of the electromagnetic spectrum extending from ultraviolet to microwave radiation. The interaction is monitored as changes in a group of properties including radiation absorption, emission or scattering, for example, Raman, fluorescent, phosphorescent, and luminescent spectra.

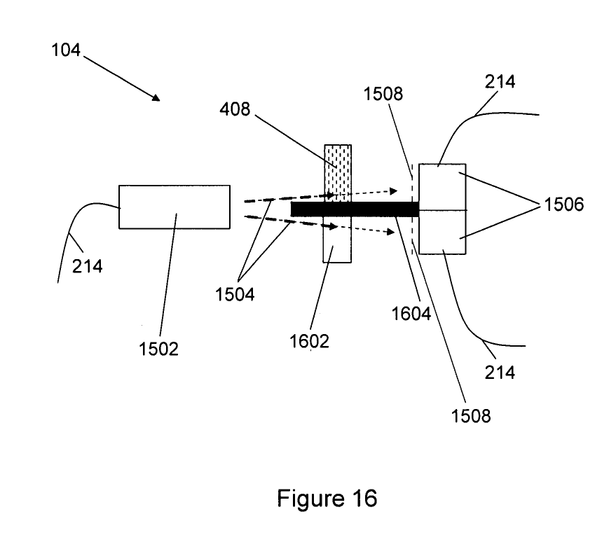

FIG. 16 is a schematic diagram of another exemplary carbon nanotube based sensor 104 that may be used with fire detector and signaling system 100 (shown in FIG. 1) using a layer of carbon nanotubes 408 to form a chemically sensitive optical filter and dual detectors. In the exemplary embodiment, carbon nanotube based sensor 104 includes a radiation source 1502 that emits a beam of radiation 1504 configured to transmit at least partially through a layer of carbon nanotubes 408 and a reference filter 1602 positioned adjacent the layer of carbon nanotubes 408. Radiation beam 1504 is configured to transmit through layer of carbon nanotubes 408 and reference filter 1602 to impinge at least twos detector 1506, which each generates an output signal representative of the amount of radiation received by each respective detector 1506, which may incorporate or be couple to wave length restrictive filters. A baffle 1604 that is opaque to radiation beam 1504 is positioned between layer of carbon nanotubes 408 and a reference filter 1602 to facilitate reducing crosstalk between the portion of radiation beam 1504 transmitting through layer of carbon nanotubes 408 and reference filter 1602. The exemplary embodiment facilitates improving stability and selectivity of carbon nanotube based sensor 104.

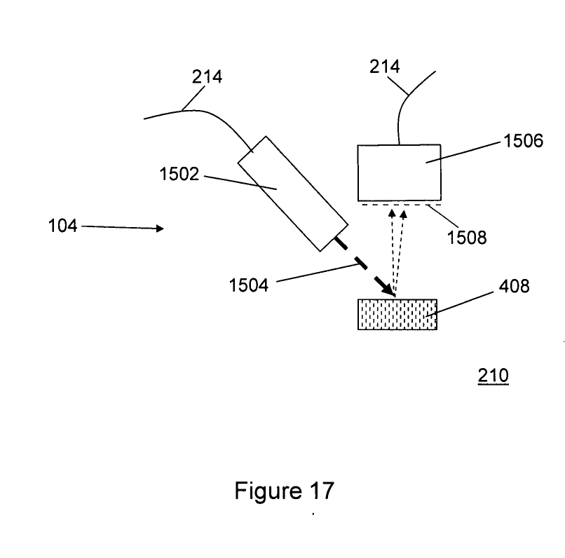

FIG. 17 is a schematic diagram of still another exemplary carbon nanotube based sensor 104 that may be used with fire detector and signaling system 100 (shown in FIG. 1) using a layer of carbon nanotubes 408 to form an optical system configured to measure fluorescence or radiation scattered from a layer of carbon nanotubes 408. In the exemplary embodiment, carbon nanotube based sensor 104 includes a radiation source 1502 that emits a beam of radiation 1504 configured to impinge at least partially on layer of carbon nanotubes 408. The interaction of radiation beam 1504 and layer of carbon nanotubes 408 causes a fluorescence or scattering of radiation beam 1504. A beam of scattered radiation or fluorescence is directed to detector 1506, which each generates an output signal representative of the amount of radiation received by detector 1506, which may incorporate or be couple to a wavelength restrictive filter. The structure of carbon nanotubes 408 is configured to respond to a concentration of gases or vapors from ambient space 210 contacting carbon nanotubes 408 such that the electronic properties of the carbon nanotube structures are affected to influence the fluorescence and scattering characteristics of carbon nanotubes 408.

Different carbon nanotube types are produced depending on the method of fabrication. The electronic properties and parameters related to such properties for different types of carbon nanotubes result in different sensitivities to chemical environments and to the suitability of such types of carbon nanotubes for use in carbon nanotube based sensors. The preferred carbon nanotube types for carbon nanotube based sensors used in fire detection systems depends on a sensor target, a device type, and a fabrication method.

In various fabrication methods, an increased proportion of carbon nanotubes of a selected type are produced. For example, a fabrication method is selected to produce a greater proportion of carbon nanotube types wherein the types include, but are not limited to single walled, multi-walled, semiconductor, metallic, types with a selected band gap range, types with a range of structural chirality, types with a range of nanotube lengths, types with a range of nanotube diameter, and types with a presence and range of structural imperfection or defects. Carbon nanotube defects may include bonding irregularities that result in wall or tube end opening, alignment changes, and diameter changes.

The device fabrication method may include control of the density of carbon nanotubes forming a carbon-based nano-structure as mats, nets, or arrays. The density of the carbon nanotubes is controlled to provide a selected conduction type or characteristic for the nano-structure based on percolation density of semiconductor and metallic nanotube particles. The device fabrication method may include preconditioning of the carbon nanotube material by exposure to environments containing reagents which selectively react with metallic conducting carbon nanotubes thereby generating carbon-based nano-structures with increased semiconductor character. The device fabrication method may include preconditioning employing passage of sufficient electrical current through the carbon-based nano-structure to damage or remove metallic conducting carbon nanotubes thereby generating carbon-based nano-structures with increased semiconductor characteristics. Such preconditioning may take place in environments containing reagents, the reaction of which with carbon nanotubes is promoted by passage of current which may include by current induced heating. Said environments may include air or oxygen atmospheres to increase oxidative damage or destruction of metallic carbon nanotubes.

Sensitivity of the electronic properties of a variety of carbon nanotube types to strongly electron withdrawing or donating molecules such as NO_{X} or NH₃ is demonstrated in a range of carbon nanotube based devices. However obtaining adequate sensitivity and selectivity to less polar or reactive molecules requires additions of material to the base carbon nanotubes. These additions may involve incorporation of non carbon atoms in the nanotubes, as dopants, or additions which generate defects or binding or reaction site on or adjacent to the carbon nanotube walls. A range of materials have been demonstrated to provide sensitization of carbon nanotube structures to gases or vapors which include examples from those associated with fire and with false alarm stimuli. It is desirable that materials capable of sensing these products be incorporated in carbon nanotube based sensors for use in fire detection. In particular catalytic metals such as platinum or palladium in contact with carbon nanotubes can induce sensitivity to relatively unreactive species including H₂, CO, and hydrocarbons. Association of carbon nanotubes with materials having polar sites can induce sensitivity to polar molecules including water vapor. Association of carbon nanotubes with materials having acid exchange sites can induce sensitivity to molecules having acidic or basic reactions including CO₂.

A carbon nanotube sensor based on chemically responsive electronic properties of carbon nanotube structures includes one or more carbon nanotubes to which one or more materials are added to change the chemical response sensitivity or selectivity. Such materials include atoms, chemical groups, molecular species, polymers, macromolecules, and organic and inorganic solids. Such materials may coat, attach to, or partially or wholly fill carbon nanotubes, may be of material in nano-particulate form, may be linked to carbon nanotubes by covalent bonds or by pi bonding interactions and may include non carbon elements including nitrogen, boron, oxygen, silicon, sulfur, phosphorus, and germanium incorporated in the nanotube structure. Materials that coat, attach to, or partially or wholly fill carbon nanotubes, including in nano-particulate form, may include one or more elements or their compounds from a group including transition, and lanthanide elements their oxides and noble and catalytic metals including platinum, palladium, gold, iridium, rhodium, silver, cobalt, nickel and copper. Such materials may be molecular species or groups including phthalocyanins, porphyrins, polycyclic aromatics, and organometallic compounds. Additionally, such material additions may be polymeric materials that may include electrically conducting or semiconductor polymers, polymeric material with ion exchange sites, polyacids including polysulfonic acids including Nafion.

It is contemplated that the present invention is applicable, not only to the optical configurations described above, but to other optical configurations as well. Therefore, the various embodiments of carbon nanotube based sensor 104 are provided by way of illustration rather than limitation. Accordingly, the foregoing descriptions are for illustrative purposes only, and are not intended to limit application of the present invention to any particular carbon nanotube or carbon nanotube based structures used in sensing concentrations of gases and vapors.

Although the embodiments described herein are discussed with respect to a fire detection system, it is understood that the sensors including carbon nanotube based sensors described herein may be used with other detection systems.

It will be appreciated that the use of first and second or other similar nomenclature for denoting similar items is not intended to specify or imply any particular order unless otherwise stated.

The above-described embodiments of a fire detection system provide a cost-effective and reliable means for applying gas sensing to fire detection. Specifically, the gas sensors for fire detection include low cost, long life and stability without need for periodic calibration, and low power use. The power limitation applies to both battery powered individually deployed detectors and to detectors forming part of building wide sensor systems where additive effects of power requirements from multiple, often hundreds, of detectors can prove excessive if individual detector power requirements are not low.

Exemplary embodiments of fire detection systems and apparatus are described above in detail. The fire detection system components illustrated are not limited to the specific embodiments described herein, but rather, components of each system may be utilized independently and separately from other components described herein. For example, the fire detection system components described above may also be used in combination with different fire detection system components.

While the invention has been described in terms of various specific embodiments, those skilled in the art will recognize that the invention can be practiced with modification within the spirit and scope of the claims.

What is claimed is:

1. A system for detecting a fire related condition, comprising:
a sensor that includes a carbon-based nano-structure, said sensor exhibiting an electronic property that varies in response to a presence of a predetermined gas indicative of a fire related condition; and
an evaluation unit, communicating with the sensor, for analyzing the electronic property to determine whether the fire related condition exists.

2. The system in accordance with claim 1, wherein the carbon-based nano-structure constitutes a carbon nanotube structure having carbon atoms linked in a cylindrical framework.

3. The system in accordance with claim 1, wherein the carbon-based nano-structure includes a structure comprising at least one of carbon nanotubes, fullerenes, carbon nanocones, carbon nano-onions, graphene sheet, and nanosized carbon particles of graphitic or amorphous type, and combinations or assemblies thereof.

4. The system in accordance with claim 1, wherein the carbon-based nano-structure including an approximately circular cross-section having a diameter of less than about 100 nanometers.

5. The system in accordance with claim 1, wherein the electronic properties of the carbon-based nano-structure that vary include at least one of current versus applied voltage, resistance, capacitance, impedance, field emission current, diode characteristics, and trans-conductance.

6. The system in accordance with claim 1, wherein the carbon-based nano-structure is responsive to gases that are at least one of generated or consumed by combustion, generated or consumed by fuel pyrolysis, and associated with false fire alarm conditions.

7. The system in accordance with claim 1, wherein the evaluation unit determines when the fire related condition constitutes at least one of combustion, pyrolysis, a leak of a gas of interest, a discharge of a liquid or solid material generating a predetermined gas of interest, and a chemical reaction of interest.

8. The system in accordance with claim 1, wherein said evaluation unit receives electrical sensor signals from the sensor and compares the sensor signals with a predetermined threshold to determine whether the fire related condition exists.

9. The system in accordance with claim 1, wherein said evaluation unit generates a control signal when the fire related condition exists, the control signal being used to at least one of generate an alert signal and initiate an automatic action that facilitates mitigating the fire related condition.

10. The system in accordance with claim 1, further comprising electrodes joined to said carbon-based nano-structure, the electrodes generating electrical sensor signals indicative of the electronic properties of the carbon-based nano-structure.

11. The system in accordance with claim 1 further comprising at least one of a scattered-light sensor, an ionization type smoke sensor, a light obscuration sensor, a flame electromagnetic emission sensor, an electrochemical carbon monoxide sensor, and a temperature sensor.

12. The system in accordance with claim 1 further comprising a housing at least partially surrounding said sensor, said housing comprising a gas permeable filter comprising materials with at least one of a size selective permeability, a physically selective permeability, a chemically selective permeability, an absorbent, a reactive, and a catalytic property wherein the materials are selectable based on a predetermined permeability profile.

13. The system in accordance with claim 1 further comprising a housing at least partially surrounding said sensor, said housing comprising a gas permeable filter that is electrically conductive, said filter configured to provide at least one of physical protection, electromagnetic screening, optical screening, and electrical contact to said carbon-based nano-structures.

14. The system in accordance with claim 1 wherein said carbon nanotube structures comprise at least one junction structure positioned at least one of between one or more carbon-based nano-structures and another electrically conducting or semiconductor material, between carbon-based nano-structures having different electronic properties wherein an electronic response to the presence of a predetermined gas is measured as a change in at least one of diode characteristics, thermoelectric characteristics, and thermoelectric power of the at least one junction structures.

15. The system in accordance with claim 1 wherein said carbon-based nano-structures comprise a field emission structure incorporating one or more carbon-based nano-structures wherein an electronic response to the presence of a predetermined gas is measured as a change in at least one of emission current and emission current versus potential characteristics of the field emission structure.

16. The system in accordance with claim 1 wherein said carbon-based nano-structures comprise a field effect transistor structure comprising three or more electrically conductive or semiconductive contacts disposed at least one of in contact with and adjacent to the carbon-based nano-structures wherein an electronic response to the presence of a predetermined gas is measured using said three or more electrical contacts as a change in at least one of current versus applied voltage, resistance, capacitance, impedance, diode characteristics, and field effect transistor characteristics, transconductance, and a change in applied potential for devices operated with fixed transconductance.

17. The system in accordance with claim 1 wherein said carbon-based nano-structures comprise an electrochemical cell structure incorporating one or more carbon-based nano-structures wherein an electronic response to the presence of a predetermined gas is measured as a change in at least one of electrode potential, cell current, and cell impedance.

18. The system in accordance with claim 1 wherein said carbon-based nano-structures comprise a device incorporating one or more carbon-based nano-structures wherein changes in the electronic properties of the carbon-based nano-structures are monitored using an interaction between the one or more carbon-based nano-structures with electromagnetic radiation.

19. The system in accordance with claim 18 wherein the electromagnetic radiation includes portions of the electromagnetic spectrum extending from ultraviolet to microwave radiation.

20. The system in accordance with claim 18 wherein an electronic response to the presence of a predetermined gas is measured as a change in at least one of radiation absorption, emission, and scattering.

21. The system in accordance with claim 20 wherein a change in at least one of radiation absorption, emission, and scattering includes a change in at least one of Raman, fluorescent, phosphorescent, and luminescent spectra.

22. The system in accordance with claim 1 wherein said carbon-based nano-structure comprises at least one of a single walled structure, a multi-walled structure, a semiconductor characteristic, a metallic characteristic, a band gap characteristic, structural chirality, substantially uniform nanotube lengths, non-uniform nanotube lengths, substantially uniform nanotube diameters, non-uniform nanotube diameters, and a presence of structural imperfections or defects.

23. The system in accordance with claim 1 wherein said carbon-based nano-structure comprises a net of carbon nanotubes having a density controlled such that the net of carbon nanotubes exhibits semiconductor properties.

24. The system in accordance with claim 1 wherein said carbon-based nano-structure comprises a net of single walled carbon nanotubes where net density is sufficiently low to maintain overall semiconductor properties for the nano-structure.

25. The system in accordance with claim 1 wherein said carbon-based nano-structure comprises a mat, net or body of carbon nanotubes, the carbon nanotubes being conditioned by reaction in an environment such that at least a portion of the carbon nanotubes are rendered non-conductive or have low conductivity thereby increasing the overall semiconductor properties of the carbon-based nano-structure

26. The system in accordance with claim 1 wherein said carbon-based nano-structure comprises a mat, net or body of carbon nanotubes that are conditioned by passing a current therethrough such that at least a portion of the metallic carbon nanotubes are thermally damaged or rendered non-conductive or to have low conductivity thereby increasing the overall semiconductor properties of the carbon-based nano-structure.

27. The system in accordance with claim 1 wherein said carbon-based nano-structures comprise at least one material addition such that the addition modifies at least one of the chemical sensitivity and the chemical selectivity of said carbon-based nano-structures.

28. The system in accordance with claim 27 wherein said material additions comprise additions that at least one of coat said carbon-based nano-structures and at least partially fill said carbon-based nano-structures.

29. The system in accordance with claim 27 wherein said material additions comprise additions that are in nanoparticulate form.

30. The system in accordance with claim 27 wherein said material additions comprise additions that are linked to said carbon-based nano-structures by at least one of covalent bonds and pi bonding interactions.

31. The system in accordance with claim 27 wherein said material additions comprise non carbon elements within said carbon-based nano-structures comprising at least one of nitrogen, boron, oxygen, silicon, sulfur, phosphorus, and germanium.

32. The system in accordance with claim 27 wherein said material additions comprise at least one of transition metals, lanthanide metals, catalytic metals, and metal compounds thereof.

33. The system in accordance with claim 27 wherein said material additions comprise at least one of Pt, Pd, Au, Ir, Rh, Ag, Co, Ni, and Cu.

34. The system in accordance with claim 27 wherein said material additions comprise at least one of polymeric material, macromolecular material, electrically conducting polymers, semiconductor polymers, polar polymers, polymers having acidic exchange sites, and polymers having ion exchange sites.

35. The system in accordance with claim 27 wherein said material additions comprise at least one of phthalocyanins, porphyrins, polycyclic aromatics, and organometallic compounds.

36. The system in accordance with claim 1 wherein said sensor includes a reference structure which is at least one of insensitive to and isolated from exposure to a predetermined gas indicative of a fire related condition such that output from said sensor in response to a presence of a predetermined gas indicative of a fire related condition is provided by the difference between variations of an electronic property of a carbon based nano-structure forming a sensing structure within said sensor and variations in the electronic properties of said reference structure.

37. The system in accordance with claim 36 where said reference structure includes a carbon based nano-structure

38. The system in accordance with claim 1 wherein heat or illumination is applied to said carbon-based nano-structures.

39. The system in accordance with claim 38 wherein said application of heat or illumination to said carbon-based nano-structures is varied in level, duration, or frequency.

40. The system in accordance with claim 39 wherein said variation in the application of heat or illumination to said carbon-based nano-structures is controlled in response to variations in the electronic properties of said carbon-based nano-structures.

41. The system in accordance with claim 40 wherein measurement of or of power requirements for said controlled variation in the application of heat or illumination to said carbon-based nano-structures in response to variations in the electronic properties is provided as a sensing input to a system for detecting a fire related condition.

42. A sensor for detecting a gas indicative of a fire related condition, the sensor comprising:
a carbon-based nano-structure configured to respond to the presence of a gas indicative of a fire related condition, the carbon-based nano-structure using a chemically responsive electronic property of the carbon nano-structure; and
an interface configured to transmit a signal indicative of a change in the electronic property in response to a presence of a predetermined gas generated by a fire related condition.

43. The sensor of claim 42, wherein the chemically responsive electronic property includes at least one of current versus applied voltage, resistance, capacitance, impedance, field emission current, diode characteristics, and trans-conductance.

44. The sensor of claim 42, wherein the carbon-based nano-structure constitutes a carbon nanotube structure having carbon atoms linked in a cylindrical framework.

45. The sensor of claim 42, wherein the carbon-based nano-structure including an approximately circular cross-section having a diameter of less than about one hundred nanometers.

46. The sensor of claim 42, wherein the carbon-based nano-structure including an approximately circular cross-section having a diameter of less than about fifty nanometers.

47. The sensor of claim 42, wherein the carbon-based nano-structure including an approximately circular cross-section having a diameter of less than about ten nanometers.

48. A method for detecting a fire related condition utilizing a sensor that includes a carbon-based nano-structure, the method comprising:
measuring an electronic property of the carbon-based nano-structure that varies in response to a presence of a predetermined gas indicative of a fire related condition; and
analyzing the electronic property to determine whether the fire related condition exists.

49. The method of claim 48 wherein analyzing the electronic property to determine whether the fire related condition exists comprises determining the presence of at least one of combustion, pyrolysis, a leak of a gas of interest, a discharge of a material generating a predetermined gas of interest, and a chemical reaction of interest.

50. The method of claim 48 wherein measuring an electronic property of the carbon-based nano-structure comprises measuring a change in an electronic property of a carbon-based nanotube structure wherein the carbon-based nanotube structure includes carbon atoms linked in a cylindrical framework having a diameter of less than about 100 nanometers.

51. The method of claim 48 wherein measuring an electronic property of the carbon-based nano-structure comprises measuring a change in at least one of a current versus applied voltage, resistance, capacitance, impedance, field emission current, diode characteristics, and trans-conductance.

52. The method of claim 48 wherein measuring an electronic property of the carbon-based nano-structure comprises measuring a change in an electronic property due to an interaction of the carbon-based nano-structure with at least one of electromagnetic radiation and ionizing radiation.
